(19) United States
(12) Patent Application Publication
(10) Pub. No.: US 2026/0258932 A1
(43) Pub. Date: Sep. 3, 2026

(54) COVER FOR A LIGHT EMITTING ASSEMBLY

(71) Applicant: Zumtobel Lighting GmbH, Dornbirn (AT)

(72) Inventors: Christoph Schwaiger, Dornbirn (AT); Laura Sandri, Dornbirn (AT)

(73) Assignee: Zumtobel Lighting GmbH, Dornbirn (AT)

(21) Appl. No.: 18/881,783

(22) PCT Filed: Sep. 27, 2023
(86) PCT No.: PCT/EP2023/076681

§ 371 Date: Jan. 7, 2025

(30) Foreign Application Priority Data
Sep. 28, 2022 (EP) 22198350.5

(51) Int. Cl. F21V 17/18; F21V 3/02

(52) U.S. Cl. CPC F21V 17/18; F21V 3/02

(57) ABSTRACT

A cover (100) for an elongated light emitting assembly (1). The cover comprises an elongated central portion (121), which extends in a first plane, and two side legs (122) provided on both sides (121L, 121R) of the central portion (121), whereby the cover (100) is at least partially light-transmitting. Further, the side legs (122) are each connected to the central portion (121) via a hinge joint (123) in such a way that the side legs (122) can be pivoted (pv) from a first position (P1), in which they extend substantially in the first plane of the central portion (121), into a second position (P2), in which they are aligned at an angle to the central portion (121).

Moreover, the hinge joints (123) are each formed by a connecting portion which is made of a material of increased flexibility and which connects the central portion (121) to the associated side leg (122) in a materially locking manner.

### CROSS-REFERENCE TO RELATED APPLICATION

The present application is the U.S. national stage application of international application PCT/EP2023/076681 filed Sep. 27, 2023, which international application was published on Apr. 4, 2024 as International Publication WO 2024/068718 A1. The international application claims priority to European Patent Application No. 22198350.5, filed Sep. 28, 2022.

### TECHNICAL FIELD OF THE INVENTION

The invention relates to a foldable optic cover, which can be reversibly connected to a support member of a light emitting assembly, closing the light emitting assembly in the direction of light emission.

### BACKGROUND OF THE INVENTION

Currently known covers for an elongated light emitting assembly are usually shaped substantially planar, and in this way close off an opening of the support member flat, and thus only allow light to be emitted in one direction, namely downwards relative to the light emitting assembly.

An example of such a known cover is shown in FIG. 3. Here, a cross-section of a carrier element or support member 2000 of an elongated light emitting assembly is shown, whereby it can be seen that the cover 1000 is essentially flat and substantially only has one plane, and is inserted into the opening 2010 of the support member 2000. In this respect, the light emitted by the light source 3000, which is positioned within the cross-sectional U-shaped interior of the light emitting assembly, is only emitted over one surface of the light emitting assembly, namely the cover 1000. Such flat covers 1000 have the advantage of being stored in a rolled-up manner.

However, these known rollable covers are not suitable for applications in which light emission is also required via side surfaces of the light emitting assembly, having the commonly known substantially U-shaped support members.

While known dropped diffuser covers would allow such light emission, these are usually inflexible and are also produced in predetermined short lengths, so that several dropped diffuser covers of pre-fixed length have to be lined up to cover the support members of one light emitting assembly, whereby visible and unaesthetic light deflections are produced at the contact points of the separate covers, resulting in a more inhomogeneous light emission of the elongated light emitting assembly as a whole. Furthermore, with such rigid covers, it is not possible to realize certain patterns of the support member (e.g. different height patterns, as a concave and/or convex pathway). These individual covers are also susceptible to expansion and shrinkage effects, which are based, for example, on the respective ambient conditions of the luminaire and the generated waste heat, which further negatively influence a homogeneous and aesthetic light emission.

Thus, the currently known covers and respective elongated light emitting assembly were found to be disadvantageous for a homogenous and multidirectional light emission. The invention is concerned with the task of providing a cover for an elongated light emitting assembly with an improved homogenous and multidirectional light emission. This task is solved by the cover for an elongated light emitting assembly according to independent claim 1.

### SUMMARY OF THE INVENTION

According to the invention the cover for an elongated light emitting assembly comprises:
an elongated central portion extending in a first plane, and
two side legs provided on both sides of the central portion,
   whereas the cover is at least partially light-transmitting, and
   wherein the side legs are each connected to the central portion via a hinge joint in such a way that the side legs can be pivoted from a first position, in which they extend substantially in the first plane of the central portion, into a second position, in which they are aligned at an angle to the central portion. Hereby the hinge joints are each formed by a connecting portion which is made of a material of increased flexibility and which connects the central portion to the associated side leg in a materially locking manner.

The such configured cover for an elongated light emitting assembly with its two side legs and central portion forms a dropped diffusor structure, when put into the second position, while providing an utterly flat structure when in the first position. This variable structure is provided via the hinge between each side leg and the elongated central portion. In this flat configuration of the cover, i.e. the first position of the side legs, the cover is particularly easy to pack and store in a space-saving manner. Furthermore, in the second position, i.e. the position the cover takes e.g. when closing the opening of the support member, the side legs extend the distance from a light source to the central portion, so that improved light mixing is achieved, and light can also be emitted via the side legs. The materially locking and thus the integral design of the side legs, the central portion and the joint hinges also creates a particularly simple, stable and cost-effective structure. Despite the mobility of the individual elements, this design further enables the cover at the joint hinges to be durable and tight, preventing dust, moisture and water from entering the interior of the respective light emitting assembly. With the at least partially light-transmitting characteristics, it is possible that all parts (central portion, side legs) of the cover are equally light-transmitting, or that the light-transmission abilities of the parts differ, even including the possibility that one (or more parts) are non-translucent. Whereas in an implementation where the central portion is at least partially light-transmitting the central portion is a central light emitting portion.

Furthermore, the elongated light emitting assembly itself is provided, having a support member extending in a longitudinal direction for receiving lighting means, the support member having an opening extending in the longitudinal direction, and a respective cover closing the opening of the support member.

Different exemplary embodiments and configurations of the cover are provided subsequently. It is understood that these various exemplary implementations of the cover are compatible with such a light emitting assembly with a support member.

Optionally the side legs are profiled at their end opposite the central portion and thereby form a latching structure by means of which fastening of the cover to a support member of the light emitting assembly is enabled. This ensures a particularly simple, effective and stable coupling of the cover to the support member via form fit.

According to the invention the central portion and the side legs are made of the same material, preferably of PMMA or alternatively another suitable plastic material. Hereby the manufacturing effort is reduced, whereas furthermore the cover is particularly variable, light and durable.

Further optionally the central portion and/or the side legs have a light diffusing effect. This further homogenizes the light emission over the respective surface, so that a particularly pleasant and aesthetic light emission is achieved.

Hereby the material of the central portion and/or the side legs may optionally comprise light diffusion elements or wherein the central portion and/or the side legs have a light diffusing surface structure. Hereby, the respective light emissions over the corresponding surfaces can be individually designed in different ways, so that the respective cover can be adapted to the respective lighting circumstances. It could be envisaged, for example, that the light diffusion elements, for example in the form of a foil attached to the surface of the cover, are changeable.

Additionally, optionally the central portion and/or the side legs have a thickness of about 0.5 to 5 mm, preferably about 1 to 3 mm and further preferably about 2 mm. The thickness of the material can be used to influence the weight and stability of the cover, with the cover becoming more durable with increasing thickness. Furthermore, the thickness has an influence on the light mixing. The thickness of 2 mm has turned out to be the preferred value as a compromise of the various factors. Preferably the central portion and the side legs have the same thickness. This increases the stability of the cover, while the light mixture is similar on all sides.

Optionally the central portion and the side legs are formed at their edge adjacent to the hinge joint in such a way that the deflection of the side legs is limited to a maximum angle. This prevents overstretching of the hinge joint and thus damage to the material of increased flexibility. Furthermore, the assembly of the cover is facilitated, and thus also the assembly of the light emitting assembly. Preferably, the maximum angle is reached in a region around the second position of a side leg. Furthermore, such a restriction of the angle serves the stability of the coupling of cover and support member, since in particular a clamped or snapped-in bond between these elements is strengthened thereby.

Hereby preferably the central portion and the side legs have webs at their edge adjacent to the hinge joint which abut against each other when the maximum angle of deflection is reached. This is a particularly simple and effective structural design for limiting the angle. In the second position, the webs support the stability of the respective side leg, while in the first position the maximum height of the cover is barely increased, as the supporting structure is divided between the two elements side leg and respective edge of the central portion. Further preferably the maximum angle of deflection is about 90°. This enables the practically relevant areas of the positioning of the two side legs. In other preferred implementations the maximum angle of deflection is <90° or >90° (or further preferred <<90° or >>90°) such that individual structures of the cover in the second position are possible. With such other maximum deflection angles being different than 90° the cover may be trapezoidal shaped for example.

Optionally, the central portion and the side legs are formed such that the cover can be rolled up about an axis oriented substantially perpendicular to the longitudinal extension of the cover in a state in which the side legs assume the first position. This allows the cover to be stored and transported in a particularly simple and space-saving manner, with large lengths of the cover being possible. In particular, a so-called “endless light band” can be realized, whereby a long support member or several support members arranged in a row interact with the same cover, so that continuous light emission areas are created without gaps or other disturbing influences.

Further advantageously, the cover is designed in such a way that it can be shortened in a simple manner, and thus individually adapted to a specific length. It is particularly advantageous that for each elongated light emitting assembly an uninterrupted cover covers the opening of the contained support member(s). In particular, this allows lengths of the covers according to the invention to be realized which are greater than 10 meters or greater than 50 meters, although extreme lengths of over 100 meters are also conceivable. It has been shown that lengths of 16 to 20 meters are usually required, which can be easily realized with the cover according to the invention.

Optionally the cover is manufactured in a multi-component extrusion process. This simplifies the production process, and it is also possible to realize different individual lengths of the cover. In addition, the cover produced in this way is particularly durable.

Furthermore, it is conceivable that the hinge joints, which are made of a material with increased flexibility, may generate a kind of restoring force as soon as they are moved out of the first position towards the second position. This restoring force acts on the respective side leg in such a way that it is pressed in the direction of the first position. The side legs, which already interact with the support member, are thus pressed more strongly against the support member, so that a particularly secure coupling of the cover with the support member is created. In this respect, this design of the cover with the hinge joints can already achieve a coupling of the cover with the support member via force fit.

### BRIEF DESCRIPTION OF THE DRAWINGS

The invention is explained in detail below with reference to examples of embodiments and with reference to the drawing. The figures show:

FIG. 1A is an exemplary schematic cross-sectional representation of an embodiment of a cover for an elongated light emitting assembly according to the invention, whereas the cover is displayed in the first position, i.e. lying flat;

FIG. 1B is an exemplary schematic cross-sectional representation of an embodiment of a cover for an elongated light emitting assembly according to the invention, whereas the cover is displayed in a position between first position and second position;

FIG. 1C is an exemplary schematic cross-sectional representation of an embodiment of a cover for an elongated light emitting assembly according to the invention, whereas the cover is displayed in the second position, i.e. with fully erected side legs protruding from the elongated central portion;

FIG. 2 is an exemplary cross-sectional illustration of an embodiment of an elongated light emitting assembly having a support member and a cover, whereas the cover interacts with the support member and closes the opening of the support member;

FIG. 3 is an exemplary cross-sectional illustration of an embodiment of an elongated light emitting assembly according to the known prior art, having a support member and a planar cover closing the opening of the support member.

### DETAILED DESCRIPTION OF THE EXEMPLARY EMBODIMENT

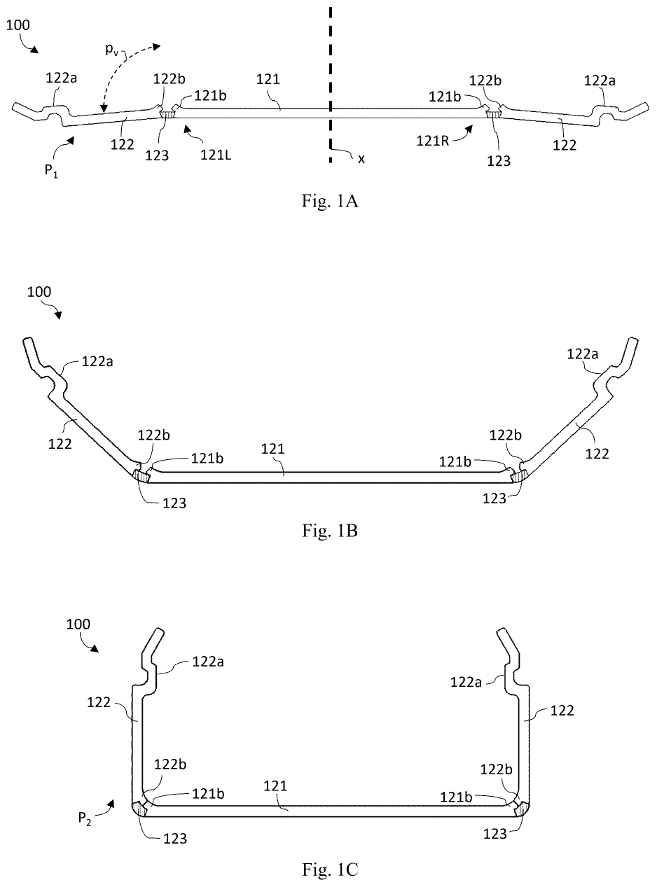

FIGS. 1A, 1B and 1C each show an exemplary embodiment of the cover 100 for an elongated light emitting assembly 1 according to the invention. It is not derivable from these Figures that the cover 100 itself is elongated as well, as the longitudinal axis is perpendicular to the shown the cross-sectional axis of the cover. The FIGS. 1A to 1C display a cross-sectional view perpendicular to the longitudinal extension of the cover 100.

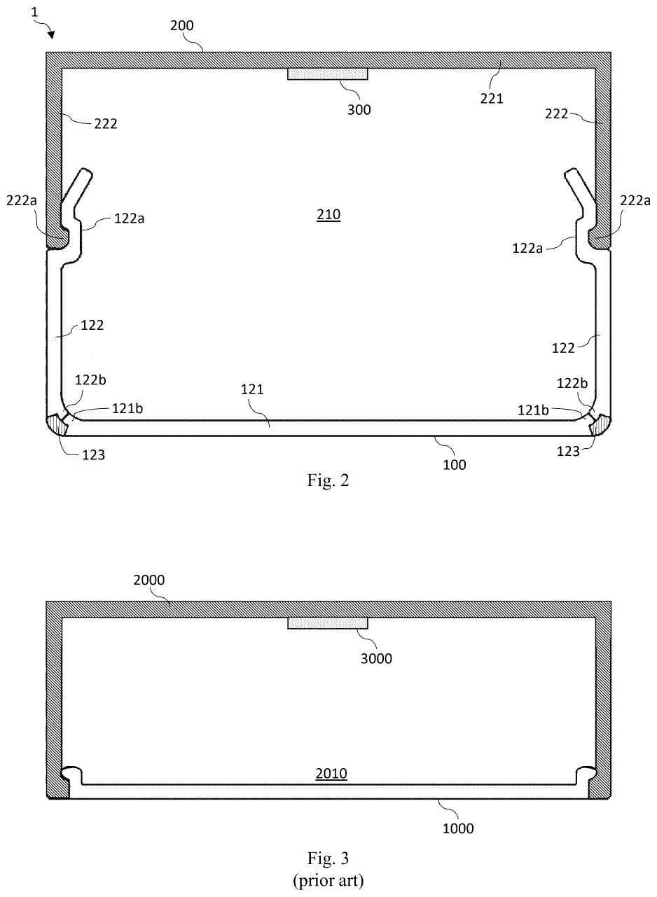

The FIGS. 1A to 1C each show the cover 100 in an orientation where the upper side of the elongated central portion 121 is designated to face the respective lighting means 300 when installed in a light emitting assembly 1. Thus, this side of the cover forms an inner side of the cover, whereas the opposite side, which is displayed as a bottom side of the elongated central portion 121 in FIG. 1A, forms an outer side of the cover, which simultaneously forms the light emission surface of the cover and thus the light emitting assembly 1. In the shown implementation the central portion 121 in FIGS. 1A, 1B, 1C and 2 is designed at least partially light-transmitting, thus the central portion 121 is a central light emitting portion 121.

The synopsis of FIGS. 1A to 1C discloses the transition between the first position P1 of the cover 100 (see FIG. 1A), which substantially corresponds to a delivery state of the cover 100 where the elongated cover is preferably transported in a rolled-up manner, and the second position P2 of the cover 100 (see FIG. 1C), which substantially corresponds to the use state when the cover 100 is used as part of an elongated light emitting assembly 1, preferably interacting with a support member 200 of the light emitting assembly 1. FIG. 1B shows an intermediate position of the side legs 122 of the cover 100, i.e. the bending of the side legs 122, and illustrates the flexibility of the material of the hinge joints 123, which connect the side legs 122 and the elongated central light emitting portion 121 of the cover 100.

As can be seen from FIG. 1A, in the first position the cover 100 is approximately plate-shaped and substantially arranged in a flat manner. The cover 100 consists essentially of the three main elements, the elongated central light emitting portion 121 and two side legs 122 which are arranged laterally to the central light emitting portion 121, whereas these side legs 122 are connected to the central light emitting portion 121 via hinge joints 123 in a materially locking manner.

The elongated central light emitting portion 121 hereby extends in a first plane, whereas in the first position P1, the side legs 122 are also arranged approximately in this first plane. The two side legs 122 are provided on both sides 121L, 121R of the central light emitting portion 121, and preferably are further at least partially light-transmitting, such that light emission is possible through the side legs 122 as well as the central light emitting portion 121.

Preferably the hinge joints 123, which are each formed by a connecting portion which is made of a material of increased flexibility also is preferably translucent. In a further preferred implementation the cover 100 completely consists of at least partially light-transmitting parts, improving light emission characteristics of the cover 100. Preferably the components of the cover 100 are equally light-transmitting resulting in a more uniform light emission.

As the cover 100 as a whole is at least partially light-transmitting, it is further conceivable only some parts—i.e. the central portion 121 and/or one or two of the side legs 122—are partially or completely translucent, such that the respective other parts are non-translucent, i.e. optically opaque. Hereby it is possible that e.g. only the central portion 121 is at least partially light-transmitting, whereas the two side legs 122 are non-light-transmitting. Furthermore, it is also possible that only one or both of the two side legs 122 are light-transmitting, whereas the central portion 121 is non-translucent. With these possibilities different lighting scenarios can be achieved, whereas directional light emission is improved, allowing for a (one or two) sided light emission via the side legs 122 additionally or alternatively to the traditional downwards light emission via the central portion 121.

The side legs 122 can each be folded up out of the plane of the central light emitting portion 121 about an axis formed by the respective hinge joint 123 and visualized in FIG. 1A by the pivoting motion py. While the pivoting motion py is only indicated for one of the side legs 122, of course the respective opposite side leg 122 is equally pivotable. Furthermore, the cover 100 is formed mirror-symmetrically to an axis x, which is perpendicular to and centred on the central light emitting portion 121.

As further shown in FIG. 1A the ends of the side legs 122 and the two sides 121L, 121R of the central light emitting portion 121, which are connected to each other via the respective hinge joint 123, each have a restriction structure 121b, 122b that restricts the pivoting motion py by interaction. In particular, the central light emitting portion 121 and the side legs 122 have webs 121b, 122b at their edge adjacent to the hinge joint 123 which abut against each other when the maximum angle of deflection is reached. These protruding webs 121b, 122b are thus arranged on the inner side of the cover 100. In the use state (second position P2) of the cover 100, these webs 121b, 122b support the stability of the cover 100 and support the installation of the cover 100 in the elongated light emitting assembly 1. Through the arrangement of the webs 121b, 122b on the inner side of the cover 100, the cover 100 and thus also the elongated light emitting assembly 1 look particularly aesthetic to a viewer.

As indicated in FIGS. 1A to 1C the central light emitting portion 121 and the side legs 122 are made of the same material, preferably of PMMA. Whereas the material of the hinge joints 123 differs, as it is made of a more flexible material. Hereby, when transitioning the cover 100 from the first position P1 to the second position P2 the hinge joints 123 are bent allowing for the fold up of the side legs 122. When bending a hinge joint 123 the inner surface of the joint hinge 123 (i.e. the surface facing the inner side of the cover 100) is compressed, whereas the opposing outer surface of the joint hinge 123 is stretched. This is apparent from the combined view of FIGS. 1A, 1B and 1C.

Preferably depending on the material selected for the hinge joints 123, a respective strong or weak restoring force can be generated when a respective hinge joint 123 is bent (i.e. when the cover 100 is not in the first position P1), which acts against the rising pivoting motion py of the side legs 122. In the use state, i.e. when the cover is in the second position P2 and interacts with the support member 200, this restoring force strengthens the coupling of the two components so that the hinge joints 123 establish a coupling via frictional connection.

As apparent from FIGS. 1A to 1C the cover 100 is sealed to itself, so that no foreign material can pass from one side of the cover 100 through the cover 100 to the other side of the cover 100. This is achieved in particular by bonding the components of the cover 100 in a materially locking manner. A multi-component extrusion process is particularly advantageous for achieving this composite of the cover 100.

The webs 121b, 122b additionally enclose the hinge joints 123 on the inside of the cover 100 for greater stability and wear reduction. Thus, the central light emitting portion 121 and the side legs 122 are formed at their edge adjacent to the respective hinge joint 123 in such a way that the deflection of the side legs 122 is limited to a maximum angle, which preferably is about 90°, as visualized in FIG. 1C. However other implementations are also possible, where the maximum angle of deflection is different to 90° (e.g. approximately 45°, 60°, 75°, 105°, 120°, 135°, or the like). These different implementations are not shown in the Figures presented herein, whereas it is clear how the cover 100 would be structured and formed for such configurations.

As further shown in the FIGS. 1A to 1C the side legs 122 are profiled at their end opposite the central light emitting portion 121 and thereby form a latching structure by means of which fastening of the cover 100 to a support member 200 of the light emitting assembly 1 is enabled, as exemplary shown in FIG. 2. These coupling structures 122a of the side legs allow for a form fit of the cover 100 interacting with a support member 200. Furthermore, the structures 122a may also be formed to have an angled protruding section, which allows for a facilitated insertion of the structures 122a of the side legs 122 into e.g. side walls 222 of a support member 200. The structures 122a preferably comprise a receiving area in which a respective protrusion 222a of the side walls 222 of the support member 200 is received. The connection of the structures 122a and the respective counterpart of the support member 200 is reversible, such that the inside of the light emitting assembly 1 is easily reachable, whereas it is also possible to change the whole cover 100 of a respective light emitting assembly 1, e.g. for maintenance reasons.

FIG. 2 further shows an exemplary embodiment of a light emitting assembly 1, which comprises the support member 200 and the cover 100. The support member 200 extends in a longitudinal direction for receiving lighting means 300 and has an opening 210 extending in the longitudinal direction, whereas the cover 200 closes the opening 210 of the support member 200. Hereby the cover 100 interacts with the support member 200 so that the opening 210 of the support member 200 is covered by the cover 100. In this respect, the cover 100 closes the light emitting assembly in the light emitting direction of the lighting means 300.

The light emitted by the lighting means 300, which are arranged inside the light emitting assembly 1, and in particular between the side walls 222 on the central plate 221 of the support member, is thus emitted both via the central light emitting portion 121 and via the side legs 122, so that light emission is achieved laterally and below the light emitting assembly 1.

Here, it is provided that the central light emitting portion 121 and/or the side legs 122 have a light diffusing effect, to provide a more homogenous light emission of the light emitting assembly 1. In this matter, the material of the central light emitting portion 121 and/or the side legs 122 may comprise light diffusion elements. Alternatively or additionally, the central light emitting portion 121 and/or the side legs 122 may also have a light diffusing surface structure.

Preferably the central light emitting portion 121 and/or the side legs 122 have a thickness of about 0.5 to 5 mm, preferably about 1 to 3 mm and further preferably about 2 mm. Further preferably the central light emitting portion 121 and the side legs 122 have the same thickness. With variation of the thickness of the material the weight, durability/stability and light emission characteristics of the cover 100 can be influenced.

Furthermore, the central light emitting portion 121 and the side legs 122 are formed such that the cover 100 can be rolled up about an axis oriented substantially perpendicular to the longitudinal extension of the cover 100 in a state in which the side legs 122 assume the first position P1, as previously mentioned. With this implementation the cover 100 can be any desired length, and still be easily transportable and storable. Further preferred, the cover 100 is easily cuttable to provide any individual light emitting assembly 1 with an appropriately adapted cover 100.

In this respect, a foldable optic is disclosed herein as a cover 100 for a support member 200 of an elongated light emitting assembly 1. This foldable optics, i.e. the cover 100, covers the opening 210 of the support member 200 in a dropped manner and allows a multidirectional light emission. With the bendable configuration of the hinge joints 123, which allow for a change of position of the side legs 122 towards the central light emitting portion 121 along a pivoting motion py, the cover 100 is substantially flat and planar in the first position P1. Due to this, the cover 100 may be designed rollable, which facilitates storing and packing. This also enables particularly long (or short) lengths of a cover 100 for individual lighting scenarios, such that solely one cover 100 is needed for an elongated light emitting assembly 1. Hereby the cover 100 seals the elongated light emitting assembly 1 over its entire length and protects its inside—and especially the therein mounted electronics, such as lighting means 300 —from external influences, such as dust, moisture or water. In addition, the cover 100 achieves a particularly aesthetic and homogeneous light emission over all light emitting surfaces of the cover 100.

1. A cover (100) for an elongated light emitting assembly (1) comprising:
an elongated central portion (121) extending in a first plane, and
two side legs (122) provided on both sides (121L, 121R) of the central portion (121),
whereas the cover (100) is at least partially light-transmitting, and
wherein the side legs (122) are each connected to the central portion (121) via a hinge joint (123) in such a way that the side legs (122) can be pivoted (pᵥ) from a first position (P₁), in which they extend substantially in the first plane of the central portion (121), into a second position (P₂), in which they are aligned at an angle to the central portion (121), and
wherein the central portion (121) and the side legs (122) are made of the same material, whereas the material of the hinge joints (123) differs, as it is made of a more flexible material,
wherein the hinge joints (123) are each formed by a connecting portion which is made of the material of increased flexibility and which connects the central portion (121) to the associated side leg (122) in a materially locking manner.

2. The cover for an elongated light emitting assembly according to claim 1, wherein the side legs (122) are profiled at their end opposite the central portion (121) and thereby form a latching structure by means of which fastening of the cover (100) to a support member (200) of the light emitting assembly (1) is enabled.

3. The cover for an elongated light emitting assembly according to claim 1, wherein the central portion (121) and the side legs (122) are made of PMMA.

4. The cover for an elongated light emitting assembly according to claim 1, wherein the central portion (121) and/or the side legs (122) have a light diffusing effect.

5. The cover for an elongated light emitting assembly according to claim 4,
wherein the material of the central portion (121) and/or the side legs (122) comprises light diffusion elements or
wherein the central portion (121) and/or the side legs (122) have a light diffusing surface structure.

6. The cover for an elongated light emitting assembly according to claim 3,
wherein the central portion (121) and/or the side legs (122) have a thickness of about 0.5 to 5 mm, preferably about 1 to 3 mm and further preferably about 2 mm,
and wherein preferably the central portion (121) and the side legs (122) have the same thickness.

7. The cover for an elongated light emitting assembly according to claim 1, wherein the central portion (121) and the side legs (122) are formed at their edge adjacent to the hinge joint (123) in such a way that the deflection of the side legs (122) is limited to a maximum angle.

8. The cover for an elongated light emitting assembly according to claim 7, that the central portion (121) and the side legs (122) have webs (121b, 122b) at their edge adjacent to the hinge joint (123) which abut against each other when the maximum angle of deflection is reached.

9. The cover for an elongated light emitting assembly according to claim 7,
wherein the maximum angle of deflection is about 90°; or
wherein the maximum angle of deflection is >90° or <90°.

10. The cover for an elongated light emitting assembly according to claim 1, wherein the central portion (121) and the side legs (122) are formed such that the cover (100) can be rolled up about an axis oriented substantially perpendicular to the longitudinal extension of the cover (100) in a state in which the side legs (122) assume the first position (P₁).

11. The cover for an elongated light emitting assembly according to claim 1, wherein the elongated central portion (121) and/or at least one of the side legs (122) is not light-transmitting.

12. The cover for an elongated light emitting assembly according to claim 1, wherein the cover (100) is manufactured in a multi-component extrusion process.

13. An elongated light emitting assembly (1) having a support member (200) extending in a longitudinal direction for receiving lighting means (300), the support member (200) having an opening (210) extending in the longitudinal direction,
and a cover (100) closing the opening (210) of the support member (200) according to claim 1.
